(19) United States
(12) Patent Application Publication
(10) Pub. No.: US 2026/0116189 A1
(43) Pub. Date: Apr. 30, 2026

(54) METHOD, INFORMATION PROCESSING APPARATUS, AND NON-TRANSITORY COMPUTER READABLE MEDIUM

(71) Applicant: TOYOTA JIDOSHA KABUSHIKI KAISHA, Toyota-shi (JP)

(72) Inventors: Jun HIOKI, Nagakute-shi (JP); Rie MURAI, Chiba-shi (JP); Tomonari YAMAGUCHI, Miyoshi-shi (JP)

(73) Assignee: TOYOTA JIDOSHA KABUSHIKI KAISHA, Toyota-shi (JP)

(21) Appl. No.: 19/367,137

(22) Filed: Oct. 23, 2025

(30) Foreign Application Priority Data
Oct. 30, 2024 (JP) 2024-191167

(51) Int. Cl. B60K 35/28; B60R 25/24; B60W 40/08; B60W 50/14

(52) U.S. Cl. CPC B60K 35/28; B60R 25/24; B60W 40/08; B60W 50/14; B60K 2360/563; B60K 2360/741; B60R 2325/205; B60W 2040/0809; B60W 2050/146; B60W 2540/043

(57) ABSTRACT

An information processing apparatus acquires, via an in-vehicle communication apparatus of a vehicle, user information on a user linked to the vehicle. Next, the information processing apparatus identifies a terminal apparatus linked to the user. When the vehicle supports digital keys and the user has a digital key contract, the information processing apparatus displays, on a screen, first information to perform both authentication of the user and registration of a digital key to the vehicle using the identified terminal apparatus. Otherwise, the information processing apparatus displays, on the screen, second information to perform authentication of the user using the identified terminal apparatus.

### CROSS-REFERENCE TO RELATED APPLICATION

This application claims priority to Japanese Patent Application No. 2024-191167, filed on Oct. 30, 2024, the entire contents of which are incorporated herein by reference.

### TECHNICAL FIELD

The present disclosure relates to a method, an information processing apparatus, and a non-transitory computer readable medium.

### BACKGROUND

Technology related to settings on vehicles before boarding is known. For example, Patent Literature (PTL) 1 discloses an invention that shares the result of personal identification performed by a vehicle and the result of personal identification performed on a terminal.

### CITATION LIST

### Patent Literature

PTL 1: JP 2018-052430 A

### SUMMARY

There is room for improvement with respect to technology related to settings on vehicles.

It would be helpful to improve technology related to settings on vehicles.

A method according to an embodiment of the present disclosure is a method performed by an information processing apparatus, the method including:
acquiring, via an in-vehicle communication apparatus of a vehicle, user information on a user linked to the vehicle;
identifying a terminal apparatus linked to the user;
when the vehicle supports a digital key and the user has a contract for the digital key, displaying, on a screen, first information to perform both authentication of the user and registration of the digital key to the vehicle using the identified terminal apparatus; and otherwise, displaying, on the screen, second information to perform authentication of the user using the identified terminal apparatus.

An information processing apparatus according to an embodiment of the present disclosure includes a controller configured to:
acquire, via an in-vehicle communication apparatus of a vehicle, user information on a user linked to the vehicle;
identify a terminal apparatus linked to the user;
when the vehicle supports a digital key and the user has a contract for the digital key, display, on a screen, first information to perform both authentication of the user and registration of the digital key to the vehicle using the identified terminal apparatus; and
otherwise, display, on the screen, second information to perform authentication of the user using the identified terminal apparatus.

A non-transitory computer readable medium according to an embodiment of the present disclosure stores a program configured to cause an information processing apparatus to execute operations, the operations including:
acquiring, via an in-vehicle communication apparatus of a vehicle, user information on a user linked to the vehicle;
identifying a terminal apparatus linked to the user;
when the vehicle supports a digital key and the user has a contract for the digital key, displaying, on a screen, first information to perform both authentication of the user and registration of the digital key to the vehicle using the identified terminal apparatus; and
otherwise, displaying, on the screen, second information to perform authentication of the user using the identified terminal apparatus.

According to an embodiment of the present disclosure, technology related to settings on vehicles is improved.

### BRIEF DESCRIPTION OF THE DRAWINGS

In the accompanying drawings:

FIG. 1 is a block diagram illustrating a schematic configuration of a system according to an embodiment of the present disclosure;

FIG. 2 is a block diagram illustrating a schematic configuration of a terminal apparatus;

FIG. 3 is a block diagram illustrating a schematic configuration of an information processing apparatus;

FIG. 4 is a flowchart illustrating operations of the information processing apparatus;

FIG. 5 is a flowchart illustrating additional operations of the information processing apparatus; and

FIG. 6 is an example of image diagrams of screens according to the embodiment of the present disclosure.

### DETAILED DESCRIPTION

Hereinafter, an embodiment of the present disclosure will be described.

### Outline of Embodiment

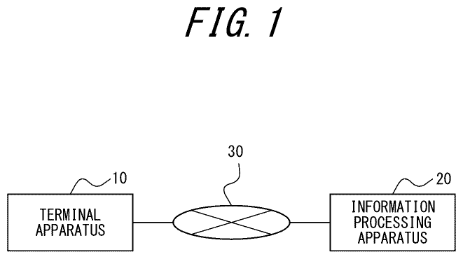

An outline of a system 1 according to the embodiment of the present disclosure will be described with reference to FIG. 1. The system 1 includes a terminal apparatus 10 and an information processing apparatus 20. The terminal apparatus 10 and the information processing apparatus 20 are communicably connected to a network 30 including, for example, the Internet, a mobile communication network, or the like.

The terminal apparatus 10 is a computer, such as a personal computer (PC), a smartphone, or a tablet terminal, for example. In the present embodiment, the terminal apparatus 10 is carried by a user. The terminal apparatus 10 is used for authentication of the user and registration of a digital key to a vehicle, as described later, when the user performs initial settings on the vehicle.

The information processing apparatus 20 is, for example, an in-vehicle apparatus installed in the vehicle, or a server that controls the vehicle via the network 30. The information processing apparatus 20 can communicate with the terminal apparatus 10 via the network 30.

First, an outline of the present embodiment will be described, and details thereof will be described later. The information processing apparatus 20 acquires, via an in-vehicle communication apparatus of the vehicle, user information on a user linked to the vehicle. Next, the information processing apparatus 20 identifies a terminal apparatus 10 linked to the user. When the vehicle supports digital keys and the user has a digital key contract, the information processing apparatus 20 displays, on a screen, first information to perform both authentication of the user and registration of a digital key to the vehicle using the identified terminal apparatus 10. Otherwise, the information processing apparatus 20 displays, on the screen, second information to perform authentication of the user using the identified terminal apparatus 10.

Thus, according to the present embodiment, the information processing apparatus 20 identifies the user and the terminal apparatus 10 linked to the user, and displays the information to perform authentication of the user and the like using the identified terminal apparatus 10. Therefore, the user can perform user registration to the vehicle necessary for initial settings of the vehicle, which is performed using the information processing apparatus 20, and operations for authentication of the user and the like, which are performed using the terminal apparatus 10, in a continuous flow. When the user needs to register a digital key with the terminal apparatus 10, the information processing apparatus 20 displays the first information in order to allow the user to perform not only authentication of the user but also registration of the digital key. When registration of a digital key is not necessary, the information processing apparatus 20 allows the user to perform only authentication of the user. Therefore, when the user has a digital key contract, the user can also register a digital key in a continuous flow. Thus, according to the present embodiment, the convenience of the operations necessary for initial settings of the vehicle is improved, thereby enhancing technology related to settings on vehicles.

Next, configurations of the system 1 will be described in detail.

### (Configuration of Terminal Apparatus)

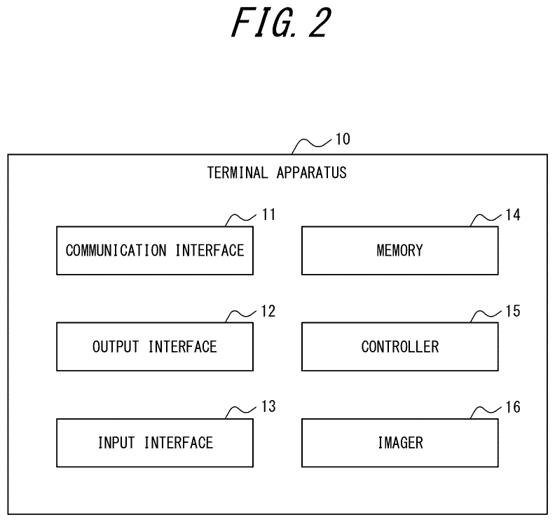

As illustrated in FIG. 2, the terminal apparatus 10 includes a communication interface 11, an output interface 12, an input interface 13, a memory 14, a controller 15, and an imager 16.

The communication interface 11 includes at least one communication interface for connecting to the network 30. The communication interface is compliant with a mobile communication standard such as the 4th generation (4G) standard or the 5th generation (5G) standard, for example, but is not limited to these. In the present embodiment, the terminal apparatus 10 communicates with the information processing apparatus 20 via the communication interface 11 and the network 30.

The output interface 12 includes at least one output device for outputting information. The output device is, for example, a display for outputting information as video, a speaker for outputting information as audio, or the like, but is not limited to these. Alternatively, the output interface 12 may include an interface for connecting to an external output device.

The input interface 13 includes at least one input device for detecting an input operation by the user. The input device is, for example, a physical key, a capacitive key, a mouse, a touch panel, a touch screen integrally provided with a display of the output interface 12, a microphone, or the like, but is not limited to these. Alternatively, the input interface 13 may include an interface for connecting to an external input device.

The memory 14 includes one or more memories. The memories are, for example, semiconductor memories, magnetic memories, optical memories, or the like, but are not limited to these. Various memories included in the memory 14 may function as, for example, a main memory, an auxiliary memory, or a cache memory. The memory 14 stores any information to be used for operations of the terminal apparatus 10. For example, the memory 14 may store a system program, an application program, embedded software, and the like. In the present embodiment, the memory 14 may store an application program for utilizing telematics service. The information stored in the memory 14 may be updated with, for example, information acquired from the network 30 via the communication interface 11.

The controller 15 includes at least one processor, at least one programmable circuit, at least one dedicated circuit, or a combination of these. The processor is, for example, a general purpose processor such as a central processing unit (CPU) or a graphics processing unit (GPU), or a dedicated processor that is dedicated to specific processing, but is not limited to these. The programmable circuit is a field-programmable gate array (FPGA), for example, but is not limited to this. The dedicated circuit is an application specific integrated circuit (ASIC), for example, but is not limited to this. The controller 15 controls operations of the entire terminal apparatus 10.

The imager 16 includes at least one camera that can read a readable two-dimensional code displayed on a screen of the information processing apparatus 20, for example.

### (Configuration of Information Processing Apparatus)

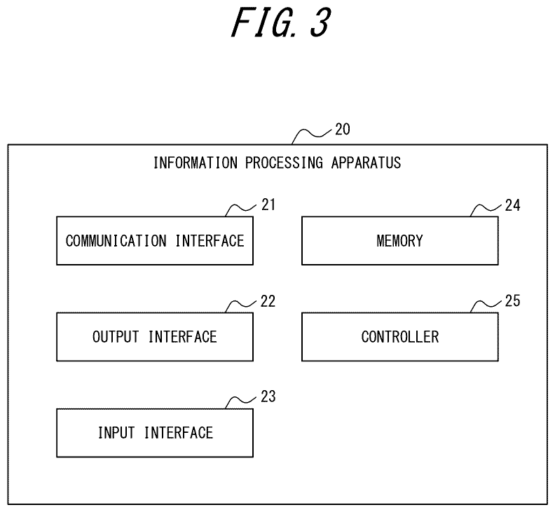

As illustrated in FIG. 3, the information processing apparatus 20 includes a communication interface 21, an output interface 22, an input interface 23, a memory 24, and a controller 25. In the present embodiment, the information processing apparatus 20 may be constituted of an in-vehicle apparatus and a server that controls the vehicle. For example, the output interface 22 and the input interface 23 of the information processing apparatus 20 may be provided in the in-vehicle apparatus, and the memory 24 and controller 25 may be provided in the server.

The communication interface 21 includes at least one communication interface for connecting to the network 30. The communication interface is compliant with, for example, but not limited to, a mobile communication standard, a wired local area network (LAN) standard, or a wireless LAN standard, and may be compliant with any appropriate communication standard. In the present embodiment, the information processing apparatus 20 communicates with the terminal apparatus 10 via the communication interface 21 and the network 30.

The output interface 22 includes at least one output device that is installed in the vehicle to output information. The output device is, for example, a display for outputting information as video, a speaker for outputting information as audio, or the like, but is not limited to these. Alternatively, the output interface 22 may include an interface for connecting to an external output device.

The input interface 23 includes at least one input device that is installed in the vehicle to detect an input operation by the user. The input device is a physical key, a capacitive key, a mouse, a touch panel, a touch screen integrally provided with a display of the output interface 22, a microphone, or the like, for example, but is not limited to these. Alternatively, the input interface 23 may include an interface for connecting to an external input device.

The memory 24 includes one or more memories. The memories included in the memory 24 may each function as, for example, a main memory, an auxiliary memory, or a cache memory. The memory 24 stores any information to be used for operations of the information processing apparatus 20. For example, the memory 24 may store a system program, an application program, embedded software, or the like. In the present embodiment, the memory 24 stores user information and vehicle information. The memory 24 may be provided in the in-vehicle apparatus or in the server. The in-vehicle apparatus and the server may constitute the entire memory 24.

The controller 25 includes at least one processor, at least one programmable circuit, at least one dedicated circuit, or a combination of these. The processor is, for example, a general purpose processor such as a central processing unit (CPU) or a graphics processing unit (GPU), or a dedicated processor that is dedicated to specific processing, but is not limited to these.

The programmable circuit is a field-programmable gate array (FPGA), for example, but is not limited to this. The dedicated circuit is an application specific integrated circuit (ASIC), for example, but is not limited to this. The controller 25 controls operations of the entire information processing apparatus 20. The controller 25 may be provided in the in-vehicle apparatus or in the server. The in-vehicle apparatus and the server may constitute the entire controller 25.

### (Operation Flow of System 1)

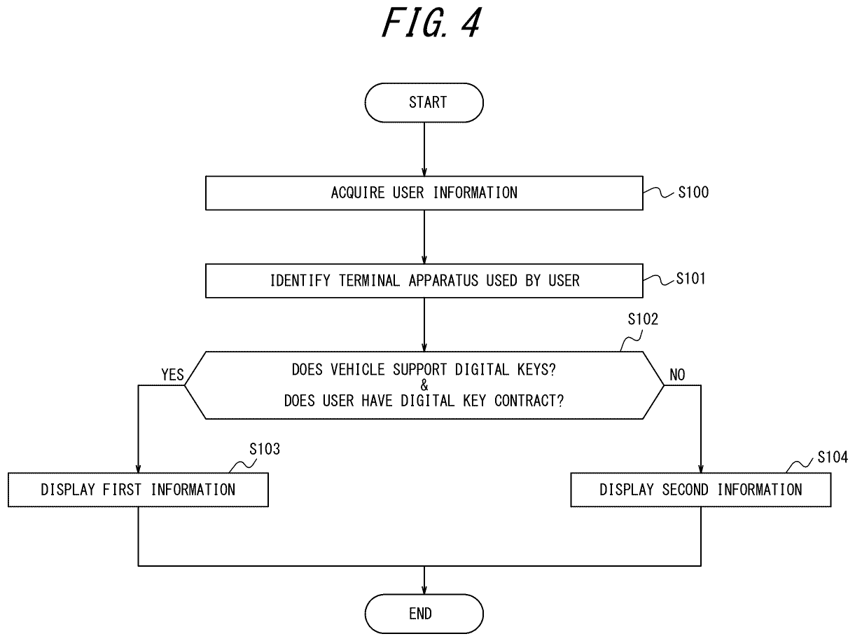

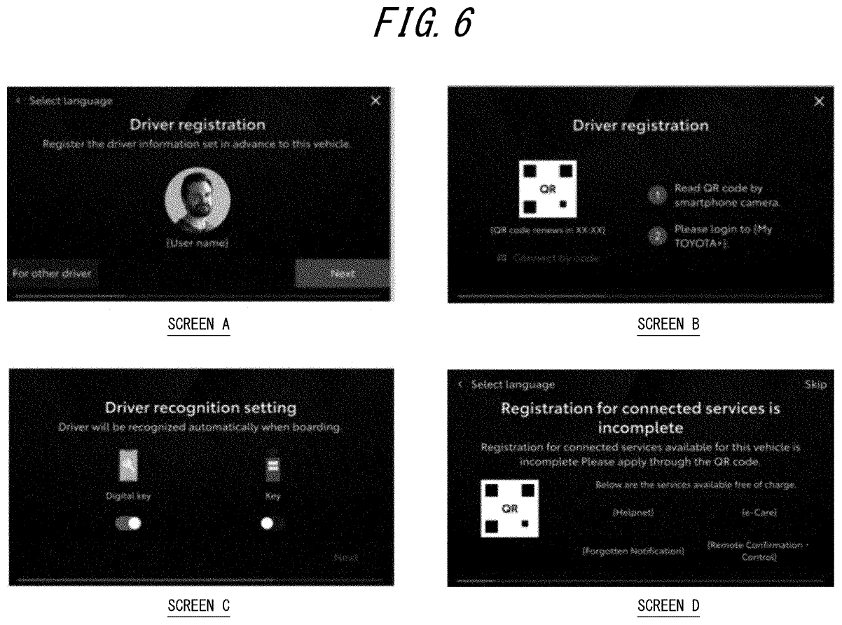

With reference to a flowchart in FIG. 4 and screen diagrams in FIG. 6, operations of the information processing apparatus 20 in the system 1 according to the present embodiment will be described.

S100: The controller 25 of the information processing apparatus 20 acquires, via an in-vehicle communication apparatus of the vehicle, user information on a user linked to the vehicle.

Specifically, upon detecting an operation for setting the vehicle by a user, the controller 25 acquires, via an in-vehicle communication apparatus of the vehicle, user information on a user linked to the vehicle, which is stored in the memory 24. Upon acquiring the user information, the controller 25 may display a user information confirmation screen, as illustrated in Screen A of FIG. 6, to have the user confirm whether the acquired user information is correct. When the user information confirmation screen is displayed, the controller 25 may proceed to the next process upon detecting an operation indicating that the user has confirmed the user information, such as pressing an “OK” button or “Next” button. When there is a plurality of users linked to the vehicle, the controller 25 may display the plurality of users linked to the vehicle on the user information confirmation screen. In this case, when the controller 25 may proceed to the next process upon detecting an operation indicating that the user has confirmed the user information, in a state in which one of the plurality of users displayed on the user information confirmation screen is selected.

The “operation for setting a vehicle by a user” may be, for example, an initial startup of an in-vehicle apparatus after purchasing the vehicle, or a specific operation such as pressing a start button on a vehicle setting screen displayed on a display of the in-vehicle apparatus. The operation for setting the vehicle by the user may be not only the initial startup of the in-vehicle apparatus but also thereafter selecting vehicle settings from a menu displayed on the display of the in-vehicle apparatus, but not limited to these operations and may be any operation.

The “user information” includes, for example, personal information such as the name and nationality of the user, the vehicle ID of the vehicle contracted by the user, the presence or absence of a digital key contract, the presence or absence of a smart key contract, the presence or absence of a communication contract for telematics service, and information identifying a terminal apparatus 10 used by the user, but not limited to these and may include any information related to the user.

S101: The controller 25 identifies a terminal apparatus 10 linked to the user.

Specifically, the controller 25 identifies a terminal apparatus 10 by acquiring information identifying the terminal apparatus 10, which is included in the user information.

The “information identifying a terminal apparatus 10” is, for example, the terminal ID of the terminal apparatus 10 or the SIM information on the terminal apparatus 10, but not limited to these and may be any information that can identify a terminal apparatus 10.

S102: The controller 25 determines whether the vehicle supports digital keys and whether the user has a digital key contract.

Specifically, the controller 25 acquires, from the memory 24, the presence or absence of digital key support included in vehicle information on the vehicle, to determine whether the vehicle supports digital keys. When the presence or absence of digital key support is “Yes”, the controller 25 determines that the vehicle supports digital keys, and acquires, from the memory 24, the presence or absence of a digital key contract included in the user information on the user, to determine whether the user has a digital key contract. When the presence or absence of a digital key contract is “Yes”, the controller 25 determines that the user has a digital key contract and proceeds to S103. When the presence or absence of digital key support is “No”, or when the presence or absence of a digital key contract is “No”, the controller 25 proceeds to S104. Note that, the order of the above processes may be reversed.

The “vehicle information” includes the presence or absence of digital key support described above, but may also include any information related to the vehicle not limited to this, such as the type of the vehicle and the presence or absence of smart key support.

S103: When the vehicle supports digital keys and the user has a digital key contract (S102—Yes), the controller 25 displays, on a screen, first information to perform both authentication of the user and registration of a digital key to the vehicle using the identified terminal apparatus 10.

Specifically, the controller 25 may display first information in the form of a two-dimensional code readable by the terminal apparatus 10, such as a QR Code® (QR code is registered trademark in Japan, other countries, or both), as illustrated in Screen B of FIG. 6.

S104: When the conditions of S102 are not satisfied (S102—No), the controller 25 displays, on the screen, second information to perform authentication of the user using the identified terminal apparatus 10.

Specifically, in the same manner as in S103, for example, the controller 25 may display second information in the form of a two-dimensional code readable by the terminal apparatus 10, such as a QR Code®, as illustrated in Screen B of FIG. 6.

As described above, the information processing apparatus 20 according to the present embodiment acquires, via an in-vehicle communication apparatus of the vehicle, user information on a user linked to the vehicle. Next, the information processing apparatus 20 identifies a terminal apparatus 10 linked to the user. When the vehicle supports digital keys and the user has a digital key contract, the information processing apparatus 20 displays, on a screen, first information to perform both authentication of the user and registration of a digital key to the vehicle using the identified terminal apparatus 10. Otherwise, the information processing apparatus 20 displays, on the screen, second information to perform authentication of the user using the identified terminal apparatus 10.

According to such a configuration, the information processing apparatus 20 identifies the user and the terminal apparatus 10 linked to the user, and displays the information to perform authentication of the user and the like using the identified terminal apparatus 10. Therefore, the user can perform user registration to the vehicle necessary for initial settings of the vehicle, which is performed using the information processing apparatus 20, and operations for authentication of the user and the like, which are performed using the terminal apparatus 10, in a continuous flow. When the user needs to register a digital key with the terminal apparatus 10, the information processing apparatus 20 displays the first information in order to allow the user to perform not only authentication of the user but also registration of the digital key. When registration of a digital key is not necessary, the information processing apparatus 20 allows the user to perform only authentication of the user. Therefore, when the user has a digital key contract, the user can also register a digital key in a continuous flow. Thus, according to the present embodiment, the convenience of the operations necessary for initial settings of the vehicle is improved, thereby enhancing technology related to settings on vehicles.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like contained in each component, each step, or the like can be rearranged without logical inconsistency, and a plurality of components, steps, or the like can be combined into one or divided.

For example, an embodiment in which the configuration and operations of the information processing apparatus 20 in the above embodiment are distributed to multiple computers capable of communicating with each other can be implemented. For example, the information processing apparatus 20 may be constituted of the in-vehicle apparatus and the server, and the in-vehicle apparatus executes some operations and the server executes the others.

For example, in the above embodiment, when the user information cannot be acquired in S100, the controller 25 may display, on the screen, third information to make a communication contract for the vehicle using the terminal apparatus 10.

Specifically, for example, when the controller 25 cannot acquire the user information on the user from the memory 24, or when the presence or absence of a communication service contract included in the user information is “No”, the controller 25 may display third information in the form of a two-dimensional code readable by the terminal apparatus 10, such as a QR Code®, as illustrated in Screen D of FIG. 6. Since the operation for making a communication contract can be performed as part of the continuous flow, the convenience of the operations necessary for the initial settings of the vehicle can be improved.

For example, following the above embodiment, the system 1 may perform the following additional operations.

### (Additional Operation Flow of System 1)

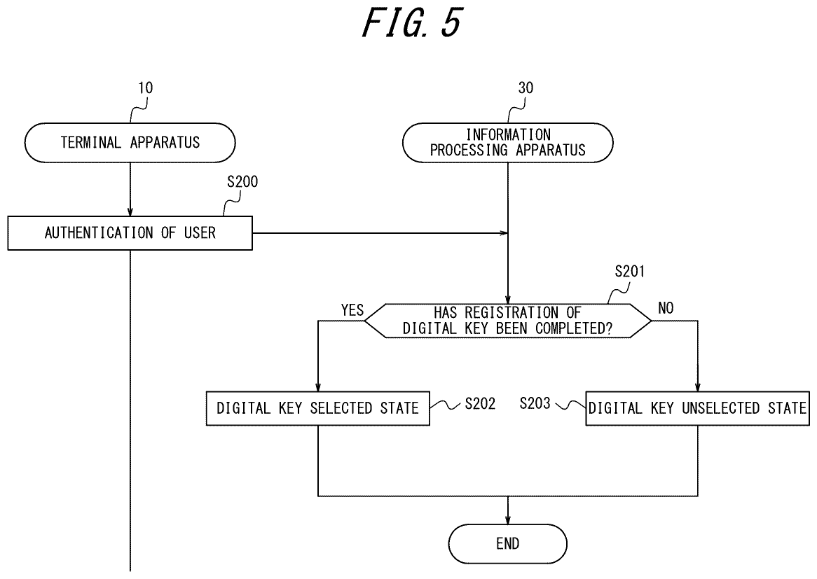

With reference to a flowchart in FIG. 5 and the screen diagrams in FIG. 6, additional operations of the terminal apparatus 10 and the information processing apparatus 20 in the system 1 according to the present embodiment will be described.

S200: The controller 15 of the terminal apparatus 10 performs authentication of the user.

Specifically, when the user reads the first information or the second information using the imager 17 of the terminal apparatus 10, the controller 15 communicates with the information processing apparatus 20 via the communication interface 11 and the network 30, to perform authentication of the user. The authentication of the user may include, for example, a one-time password or biometric authentication, but is not limited to these and may include any method used for the authentication of the user.

When the first information is read, upon completing the authentication of the user, the controller 15 displays, on a display of the output interface 12, information to perform registration of a digital key to the vehicle. In this case, the controller 25 of the information processing apparatus 20 may display, on the display of the output interface 22, information indicating that registration of a digital key is in progress until the registration of the digital key is completed. When the second information is read (when the controller 25 executes S104), upon completing the authentication of the user, the controller 15 displays such on the display. In this case, the controller 25 of the information processing apparatus 20 proceeds to S203, without executing S201.

S201: the controller 25 of the information processing apparatus 20 determines whether registration of a digital key has been completed.

Specifically, the controller 25 determines that registration of a digital key has been completed by receiving, from the terminal apparatus 10, a notification that registration of a digital key has been completed, and proceeds to S202. In this case, the controller 15 of the terminal apparatus may display such on the display of the output interface 12.

When the information indicating that registration of a digital key is in progress is displayed on the display of the output interface 22, the controller 25 may provide, on the display of the output interface 22, a button to skip the registration of the digital key. In this case, when the user presses the button, the controller 25 may proceed to S203. When registration of a digital key is not completed even after a specified time has elapsed, the controller 25 may determine that the registration of the digital key is not completed, and proceed to S203.

S202: When registration of a digital key is completed (S201—Yes), the controller 25 displays, on a screen to select and determine an identification device to identify a driver who is to drive the vehicle, the digital key in a selected state as the identification device.

Specifically, the controller 25 may display an item of the digital key with a toggle in an ON state, as illustrated in Screen C of FIG. 6, but is not limited to this and any method may be adopted.

S203: When the condition of S201 is not satisfied (S201—No), the controller 25 displays, on the screen to select and determine an identification device to identify a driver, a digital key in an unselected state as the identification device.

Specifically, the controller 25 may display a digital key with a toggle in an OFF state, rather than in an ON state, as illustrated in Screen C of FIG. 6, but not limited to this and any method may be adopted. The controller 25 may allow the digital key that is displayed in the unselected state to be selectable, or unselectable.

For example, when the vehicle does not support digital keys, the controller 25 may not display a digital key on the screen to select and determine an identification device to identify a driver.

Specifically, the controller 25 performs the process described in S102 or uses the result of the process. When the presence or absence of digital key support included in the vehicle information on the vehicle is “No”, the controller 25 determines that the vehicle does not support digital keys, and does not display a digital key on the screen.

For example, when the vehicle supports digital keys and the user does not have a digital key contract, upon detecting a user operation selecting a digital key as the identification device, the controller 25 may display, on the screen, fourth information to make a digital key contract using the terminal apparatus 10.

Specifically, the controller 25 uses the result determined in S102. When the presence or absence of digital key support included in the vehicle information on the vehicle is “Yes” and the presence or absence of a digital key contract included in the user information on the user is “No”, the controller 25 determines that the vehicle supports digital keys and that the user does not have a digital key contract. In this case, for example, when the user switches the toggle of a digital key on the screen from OFF to ON, the controller 25 may display, on the screen, fourth information in the form of a two-dimensional code readable by the terminal apparatus 10, such as a QR Code®.

For example, when registration of a digital key to the vehicle has not been completed, upon detecting a user operation selecting the digital key as the identification device, the controller 25 may display, on the screen, fifth information to register the digital key using the terminal apparatus 10.

Specifically, in a case in which registration of a digital key to the vehicle has not been completed, for example, when the user switches the toggle of the digital key on the screen from OFF to ON, the controller 25 may display, on the screen, fifth information in the form of a two-dimensional code readable by the terminal apparatus 10, such as a QR Code®.

For example, in the above embodiment, when the user has a smart key contract, upon completing the authentication of the user, the controller 25 may display, on the screen to select and determine an identification device to identify a driver, a smart key in a selectable manner as the identification device.

Specifically, the controller 25 acquires, from the memory 24, the presence or absence of a smart key contract included in the user information on the user, and determines whether the user has a smart key contract. When the presence or absence of a smart key contract is “Yes”, the controller 25 determines that the user has a smart key contract and displays an item of a smart key, as illustrated in Screen C of FIG. 6. Note that, the smart key may be selected as the identification device as illustrated in Screen C of FIG. 6, or may be unselected.

For example, in the above embodiment, the controller 25 may store the progress of the above operations, and start from the process at which an interruption has occurred when the process is interrupted.

Specifically, the controller 25 stores, in the memory 24, that a step has been completed at the completion of each step. When the process is interrupted, the controller 25 acquires, from the memory 24, which steps have been completed and starts process from the next step of the completed steps. Assuming that, for example, the power of the in-vehicle device goes off while S203 is executed. In this case, when the user restarts the in-vehicle device, the controller 25 may acquire, from the memory 24, that steps up to S202 have been executed, and start process from S203.

For example, an embodiment in which a general purpose computer functions as the information processing apparatus 20 according to the above embodiment can also be implemented. Specifically, a program in which processes for realizing the functions of the information processing apparatus 20 according to the above embodiment are written may be stored in a memory of a general purpose computer, and the program may be read and executed by a processor. Accordingly, the present disclosure can also be implemented as a program executable by a processor, or a non-transitory computer readable medium storing the program.

Examples of some embodiments of the present disclosure are described below. However, it should be noted that the embodiments of the present disclosure are not limited to these examples.

[Appendix 1] A method performed by an information processing apparatus, the method comprising:
acquiring, via an in-vehicle communication apparatus of a vehicle, user information on a user linked to the vehicle;
identifying a terminal apparatus linked to the user;
when the vehicle supports a digital key and the user has a contract for the digital key, displaying, on a screen, first information to perform both authentication of the user and registration of the digital key to the vehicle using the identified terminal apparatus; and
otherwise, displaying, on the screen, second information to perform authentication of the user using the identified terminal apparatus.
   [Appendix 2] The method according to appendix 1, further comprising upon completing the authentication of the user and the registration of the digital key to the vehicle using the terminal apparatus, displaying, on a screen to select and determine an identification device to identify a driver, the digital key in a selected state as the identification device.
   [Appendix 3] The method according to appendix 1 or 2, further comprising, when the user information cannot be acquired, displaying, on the screen, third information to make a communication contract for the vehicle using the terminal apparatus.
   [Appendix 4] The method according to any one of appendices 1 to 3, further comprising, when the user has a contract for a smart key, upon completing the authentication of the user, displaying, on a screen to select and determine an identification device to identify a driver, the smart key in a selectable manner as the identification device.
   [Appendix 5] The method according to any one of appendices 1 to 4, further comprising:
when the vehicle supports the digital key and the user does not have a contract for the digital key, upon completing the authentication of the user, displaying, on a screen to select and determine an identification device to identify a driver, the digital key in an unselected state as the identification device; and
upon detecting a user operation selecting the digital key as the identification device, displaying, on the screen, fourth information to make a contract for the digital key using the terminal apparatus.
   [Appendix 6] The method according to any one of appendices 1 to 5, further comprising:
when the registration of the digital key to the vehicle is not completed, upon completing the authentication of the user, displaying, on a screen to select and determine an identification device to identify a driver, the digital key in an unselected state as the identification device; and
upon detecting a user operation selecting the digital key as the identification device, displaying, on the screen, fifth information to perform registration of the digital key using the terminal apparatus.
   [Appendix 7] The method according to any one of appendices 1 to 6, wherein the information processing apparatus is configured to display the first information or the second information in the form of a two-dimensional code readable by the terminal apparatus.
   [Appendix 8] An information processing apparatus comprising a controller configured to:
acquire, via an in-vehicle communication apparatus of a vehicle, user information on a user linked to the vehicle;
identify a terminal apparatus linked to the user;
when the vehicle supports a digital key and the user has a contract for the digital key, display, on a screen, first information to perform both authentication of the user and registration of the digital key to the vehicle using the identified terminal apparatus; and
otherwise, display, on the screen, second information to perform authentication of the user using the identified terminal apparatus.
   [Appendix 9] The information processing apparatus according to appendix 8, wherein the controller is configured to, upon completing the authentication of the user and the registration of the digital key to the vehicle using the terminal apparatus, display, on a screen to select and determine an identification device to identify a driver, the digital key in a selected state as the identification device.
   [Appendix 10] The information processing apparatus according to appendix 8 or 9, wherein the controller is configured to, when the user information cannot be acquired, display, on the screen, third information to make a communication contract for the vehicle using the terminal apparatus.
   [Appendix 11] The information processing apparatus according to any one of appendices 8 to 10, wherein the controller is configured to, when the user has a contract for a smart key, upon completing the authentication of the user, display, on a screen to select and determine an identification device to identify a driver, the smart key in a selectable manner as the identification device.
   [Appendix 12] The information processing apparatus according to any one of appendices 8 to 11, wherein the controller is configured to:
when the vehicle supports the digital key and the user does not have a contract for the digital key, upon completing the authentication of the user, display, on a screen to select and determine an identification device to identify a driver, the digital key in an unselected state as the identification device; and
upon detecting a user operation selecting the digital key as the identification device, display, on the screen, fourth information to make a contract for the digital key using the terminal apparatus.
   [Appendix 13] The information processing apparatus according to any one of appendices 8 to 12, wherein the controller is configured to:
when the registration of the digital key to the vehicle is not completed, upon completing the authentication of the user, display, on a screen to select and determine an identification device to identify a driver, the digital key in an unselected state as the identification device; and
upon detecting a user operation selecting the digital key as the identification device, display, on the screen, fifth information to perform registration of the digital key using the terminal apparatus.
   [Appendix 14] The information processing apparatus according to any one of appendices 8 to 13, wherein the controller is configured to display the first information or the second information in the form of a two-dimensional code readable by the terminal apparatus.
   [Appendix 15] A non-transitory computer readable medium storing a program configured to cause an information processing apparatus to execute operations, the operations comprising:
acquiring, via an in-vehicle communication apparatus of a vehicle, user information on a user linked to the vehicle;
identifying a terminal apparatus linked to the user;
when the vehicle supports a digital key and the user has a contract for the digital key, displaying, on a screen, first information to perform both authentication of the user and registration of the digital key to the vehicle using the identified terminal apparatus; and
otherwise, displaying, on the screen, second information to perform authentication of the user using the identified terminal apparatus.
   [Appendix 16] The non-transitory computer readable medium according to appendix 15, wherein the operations further comprise, upon completing the authentication of the user and the registration of the digital key to the vehicle using the terminal apparatus, displaying, on a screen to select and determine an identification device to identify a driver, the digital key in a selected state as the identification device.
   [Appendix 17] The non-transitory computer readable medium according to appendix 15 or 16, wherein the operations further comprise, when the user information cannot be acquired, displaying, on the screen, third information to make a communication contract for the vehicle using the terminal apparatus.
   [Appendix 18] The non-transitory computer readable medium according to any one of appendices 15 to 17, wherein the operations further comprise, when the user has a contract for a smart key, upon completing the authentication of the user, displaying, on a screen to select and determine an identification device to identify a driver, the smart key in a selectable manner as the identification device.
   [Appendix 19] The non-transitory computer readable medium according to any one of appendices 15 to 18, wherein the operations further comprise:
when the vehicle supports the digital key and the user does not have a contract for the digital key, upon completing the authentication of the user, displaying, on a screen to select and determine an identification device to identify a driver, the digital key in an unselected state as the identification device; and
upon detecting a user operation selecting the digital key as the identification device, displaying, on the screen, fourth information to make a contract for the digital key using the terminal apparatus.
   [Appendix 20] The non-transitory computer readable medium according to any one of appendices 15 to 19, wherein the operations further comprise displaying the first information or the second information in the form of a two-dimensional code readable by the terminal apparatus.

1. A method performed by an information processing apparatus, the method comprising:
acquiring, via an in-vehicle communication apparatus of a vehicle, user information on a user linked to the vehicle;
identifying a terminal apparatus linked to the user;
when the vehicle supports a digital key and the user has a contract for the digital key, displaying, on a screen, first information to perform both authentication of the user and registration of the digital key to the vehicle using the identified terminal apparatus; and
otherwise, displaying, on the screen, second information to perform authentication of the user using the identified terminal apparatus.

2. The method according to claim 1, further comprising upon completing the authentication of the user and the registration of the digital key to the vehicle using the terminal apparatus, displaying, on a screen to select and determine an identification device to identify a driver, the digital key in a selected state as the identification device.

3. The method according to claim 1, further comprising, when the user information cannot be acquired, displaying, on the screen, third information to make a communication contract for the vehicle using the terminal apparatus.

4. The method according to claim 1, further comprising, when the user has a contract for a smart key, upon completing the authentication of the user, displaying, on a screen to select and determine an identification device to identify a driver, the smart key in a selectable manner as the identification device.

5. The method according to claim 1, further comprising:
when the vehicle supports the digital key and the user does not have a contract for the digital key, upon completing the authentication of the user, displaying, on a screen to select and determine an identification device to identify a driver, the digital key in an unselected state as the identification device; and
upon detecting a user operation selecting the digital key as the identification device, displaying, on the screen, fourth information to make a contract for the digital key using the terminal apparatus.

6. The method according to claim 1, further comprising:
when the registration of the digital key to the vehicle is not completed, upon completing the authentication of the user, displaying, on a screen to select and determine an identification device to identify a driver, the digital key in an unselected state as the identification device; and
upon detecting a user operation selecting the digital key as the identification device, displaying, on the screen, fifth information to perform registration of the digital key using the terminal apparatus.

7. The method according to claim 1, wherein the information processing apparatus is configured to display the first information or the second information in form of a two-dimensional code readable by the terminal apparatus.

8. An information processing apparatus comprising a controller configured to:
acquire, via an in-vehicle communication apparatus of a vehicle, user information on a user linked to the vehicle;
identify a terminal apparatus linked to the user;
when the vehicle supports a digital key and the user has a contract for the digital key, display, on a screen, first information to perform both authentication of the user and registration of the digital key to the vehicle using the identified terminal apparatus; and
otherwise, display, on the screen, second information to perform authentication of the user using the identified terminal apparatus.

9. The information processing apparatus according to claim 8,
wherein the controller is configured to, upon completing the authentication of the user and the registration of the digital key to the vehicle using the terminal apparatus, display, on a screen to select and determine an identification device to identify a driver, the digital key in a selected state as the identification device.

10. The information processing apparatus according to claim 8,
wherein the controller is configured to, when the user information cannot be acquired, display, on the screen, third information to make a communication contract for the vehicle using the terminal apparatus.

11. The information processing apparatus according to claim 8,
wherein the controller is configured to, when the user has a contract for a smart key, upon completing the authentication of the user, display, on a screen to select and determine an identification device to identify a driver, the smart key in a selectable manner as the identification device.

12. The information processing apparatus according to claim 8, wherein the controller is configured to:
when the vehicle supports the digital key and the user does not have a contract for the digital key, upon completing the authentication of the user, display, on a screen to select and determine an identification device to identify a driver, the digital key in an unselected state as the identification device; and
upon detecting a user operation selecting the digital key as the identification device, display, on the screen, fourth information to make a contract for the digital key using the terminal apparatus.

13. The information processing apparatus according to claim 8, wherein the controller is configured to:
when the registration of the digital key to the vehicle is not completed, upon completing the authentication of the user, display, on a screen to select and determine an identification device to identify a driver, the digital key in an unselected state as the identification device; and
upon detecting a user operation selecting the digital key as the identification device, display, on the screen, fifth information to perform registration of the digital key using the terminal apparatus.

14. The information processing apparatus according to claim 8, wherein the controller is configured to display the first information or the second information in form of a two-dimensional code readable by the terminal apparatus.

15. A non-transitory computer readable medium storing a program configured to cause an information processing apparatus to execute operations, the operations comprising:
acquiring, via an in-vehicle communication apparatus of a vehicle, user information on a user linked to the vehicle;
identifying a terminal apparatus linked to the user;
when the vehicle supports a digital key and the user has a contract for the digital key, displaying, on a screen, first information to perform both authentication of the user and registration of the digital key to the vehicle using the identified terminal apparatus; and
otherwise, displaying, on the screen, second information to perform authentication of the user using the identified terminal apparatus.

16. The non-transitory computer readable medium according to claim 15, wherein the operations further comprise, upon completing the authentication of the user and the registration of the digital key to the vehicle using the terminal apparatus, displaying, on a screen to select and determine an identification device to identify a driver, the digital key in a selected state as the identification device.

17. The non-transitory computer readable medium according to claim 15, wherein the operations further comprise, when the user information cannot be acquired, displaying, on the screen, third information to make a communication contract for the vehicle using the terminal apparatus.

18. The non-transitory computer readable medium according to claim 15, wherein the operations further comprise, when the user has a contract for a smart key, upon completing the authentication of the user, displaying, on a screen to select and determine an identification device to identify a driver, the smart key in a selectable manner as the identification device.

19. The non-transitory computer readable medium according to claim 15, wherein the operations further comprise:
when the vehicle supports the digital key and the user does not have a contract for the digital key, upon completing the authentication of the user, displaying, on a screen to select and determine an identification device to identify a driver, the digital key in an unselected state as the identification device; and
upon detecting a user operation selecting the digital key as the identification device, displaying, on the screen, fourth information to make a contract for the digital key using the terminal apparatus.

20. The non-transitory computer readable medium according to claim 15, wherein the operations further comprise displaying the first information or the second information in form of a two-dimensional code readable by the terminal apparatus.
